(19) United States
(12) Patent Application Publication
(10) Pub. No.: US 2006/0133234 A1
(43) Pub. Date: Jun. 22, 2006

(54) Optical disc apparatus

(75) Inventor: Tsutomu Inada, Osaka (JP)

Correspondence Address: CROWELL & MORING LLP;INTELLECTUAL PROPERTY GROUP, P.O. BOX 14300, WASHINGTON, DC, 20044-4300, US

(73) Assignee: Funai Electric Co., Ltd., Daito-shi (JP)

(21) Appl. No.: 11/302,129

(22) Filed: Dec. 14, 2005

(30) Foreign Application Priority Data
Dec. 15, 2004 (JP) 2004-362943

(51) Int. Cl. G11B 7/00

(52) U.S. Cl. 369/44.29; 369/44.28; 369/44.35

(57) ABSTRACT

An optical disc apparatus includes a servo gain adjuster, which includes a disturbance signal supplying unit that generates plural disturbance signals of different frequencies and supplies them in sequence to a servo loop, a gain characteristic measuring unit that measures a deviation of a servo gain characteristic of the servo loop based on each disturbance signal passed through the servo loop, an average gain characteristic calculating unit that calculates the average of deviations of plural servo gain characteristics measured by the gain characteristic measuring unit in response to the plural disturbance signals supplied from the disturbance signal supplying unit, and a gain adjustment amount determining unit that determines an amount of adjustment to the servo gain of the servo loop based on the average of the deviations of the servo gain characteristics that is calculated by the average gain characteristic calculating unit. The optical disc apparatus can provide stable adjustments to the servo gain of the servo control that causes the focused spot of light to follow the recording track of an optical disc.

### BACKGROUND OF THE INVENTION

1. Field of the Invention

The present invention relates to an optical disc apparatus that records and/or reproduces information on an optical disc such as a compact disc (CD), a digital versatile disc (DVD), or the like.

2. Description of the Related Art

Optical disc apparatus are typically configured to focus light emitted from a light emitting element through an objective lens onto an optical disc and receive the light reflected from the optical disc through the objective lens at a light receiving element while rotating the optical disc by a spindle motor, and read information recorded on the optical disc based on output signals from the light receiving element. Further, when reading information from an optical disc, the optical disc apparatus use a servo controller thereof to drive an actuator and thereby move the objective lens based on output signals from the light receiving element so that the spot of light focused onto the optical disc follows the recording track of the optical disc.

For stable servo control, such an optical disc apparatus makes servo gain adjustments. The servo gain adjustment means an adjustment to increase or decrease the gain of the servo controller so that the open-loop characteristic of the servo loop, which includes the objective lens, the actuator, the light receiving element, and the servo controller, reaches 0 dB at a target cut-off frequency, and thereby set the cut-off frequency as designed.

The conventional optical disc apparatus supplies a single type of disturbance signal with a given frequency to the servo loop, measures a deviation of the servo gain characteristic by detecting the disturbance signal passed through the servo loop, and determines the amount of adjustment to the servo gain based on the deviation of the servo gain characteristic. As shown in FIG. 3A, assume that the gain characteristic of the actuator is not 0 dB at the target cut-off frequency but has a given gain ΔG (gain deviation). If the frequency characteristic of the actuator has no resonance point, a gain G2 is constant that is the difference between a gain G1 at the disturbance frequency and a gain G0 at the target cut-off frequency. Accordingly, determining the gradient of the gain characteristic of the actuator, the disturbance frequency, and the target frequency allows the gain G2 to be determined by calculation. The gain deviation ΔG can be determined by calculating “gain G1-gain G2”. Canceling the determined gain deviation ΔG results in 0 dB at the target cut-off frequency. Note that the gain G1 is determined by actually supplying a disturbance signal to the servo loop and detecting the disturbance signal passed through the servo loop.

However, the conventional optical disc apparatus has the following problem. As described above, the conventional apparatus determines the amount of adjustment to the servo gain based on the disturbance signal of the single frequency supplied to the servo loop. Accordingly, in the case where the frequency characteristic of the actuator has a resonance point at the same frequency as the frequency of the disturbance signal, the gain determined by supplying the disturbance signal is not the gain G1 but a gain G3 as shown in FIG. 3B. As a result, a calculated gain deviation ΔG is not the “gain G1-gain G2” but “gain G3-gain G2”, which may cause an improper adjustment to the servo gain. In other words, the conventional optical disc apparatus may cause an error in the automatic servo gain adjustment in relation to a distortion in the frequency characteristic of the actuator because it determines the servo gain adjustment amount using the disturbance signal of the single frequency.

A number of other techniques have been proposed. For example, an optical disc apparatus is known that, for adjusting the gain of the tracking servo or focus servo system, supplies a sine wave of the same frequency as the cut-off frequency as a disturbance and performs Fourier transforms on signals before and after the supply to determine the amount of adjustment to the gain at the cut-off frequency (see e.g. Japanese laid-open patent publication Hei 6-111346). An optical disc apparatus is also known that prepares plural patterns of sine waves with the same frequency and different amplitudes, detects the amount of disturbance such as eccentricity and wobbling, selects a signal pattern based on the detection to inject the selected signal into a loop, and determines the gain based on a phase difference between the injected signal and the signal passed through the loop (see e.g. Japanese laid-open patent publication 2001-167460). Further, an optical disc apparatus is known that injects a sine wave with a period n times longer than a sampling period for a servo loop, averages every nth signal passed through the loop, and determines the difference between the maximum and the minimum as an amplitude to adjust the gain (see e.g. Japanese laid-open patent publication 2004-47011). However, the above described problem cannot be solved even if the above techniques are applied.

### SUMMARY OF THE INVENTION

An object of the present invention is to provide an optical disc apparatus that can stabilize servo gain adjustments.

According to an aspect of the present invention, an optical disc apparatus comprises: a light emitting element that emits light for recording and/or reading information on an optical disc; an objective lens for focusing the light emitted from the light emitting element onto the optical disc; an actuator that moves the objective lens; a light receiving element that receives the light focused through the objective lens onto the optical disc and reflected from the optical disc to convert the light into an electric signal for output; a servo controller that generates a drive signal for the actuator based on the output signal from the light receiving element and drives the actuator by the drive signal to move the objective lens such that the focused spot of the light focused onto the optical disc follows a recording track of the optical disc; and a servo gain adjuster that supplies a disturbance signal to a servo loop to adjust a servo gain of the servo loop based on the disturbance signal passed through the servo loop, the servo loop including the objective lens, the actuator, the light receiving element, and the servo controller.

The servo gain adjuster supplies plural disturbance signals of different frequencies to the servo loop and adjusts the servo gain of the servo loop based on the plural disturbance signals passed through the servo loop.

With the above configuration, the servo gain is adjusted using plural disturbance signals of different frequencies. This can prevent the servo gain from being adjusted to be undesirably high (or low) even when the frequency characteristic of the actuator has a resonance point at the same frequency as the frequency of one of the disturbance signals, thus allowing proper adjustments to the servo gain. Accordingly, the optical disc apparatus can stabilize servo gain adjustments and thus increase in performance.

Preferably, the servo gain adjuster includes: a gain characteristic measuring unit that measures a deviation of a servo gain characteristic of the servo loop based on a disturbance signal passed through the servo loop; and an average gain characteristic calculating unit that calculates an average of deviations of plural servo gain characteristics measured in response to the plural disturbance signals by the gain characteristic measuring unit, wherein the servo gain adjuster adjusts the servo gain of the servo loop based on the average of the deviations of the servo gain characteristics that is calculated by the average gain characteristic calculating unit.

With this configuration, the servo gain is adjusted based on the average of deviations of servo gain characteristics measured using plural disturbance signals of different frequencies. Accordingly, the servo gain can be adjusted more properly and more stably.

Preferably, the servo gain adjuster includes: a disturbance signal supplying unit that generates plural disturbance signals of different frequencies and supplies the plural disturbance signals in sequence to the servo loop; a gain characteristic measuring unit that measures a deviation of a servo gain characteristic of the servo loop based on a disturbance signal supplied to the servo loop by the disturbance signal supplying unit and passed through the servo loop; an average gain characteristic calculating unit that calculates an average of deviations of plural servo gain characteristics measured by the gain characteristic measuring unit in response to the plural disturbance signals supplied from the disturbance signal supplying unit; and a gain adjustment amount determining unit that determines an amount of adjustment to the servo gain of the servo loop based on the average of the deviations of the servo gain characteristics that is calculated by the average gain characteristic calculating unit.

Preferably, the plural disturbance signals supplied to the servo loop are two to ten types of disturbance signals that have different frequencies.

With this configuration, since about two to ten types of disturbance signals are used for adjusting the servo gain, the adjustment does not require much time. Accordingly, for example, where the servo gain is adjusted at the start of reading information from the optical disc, video and audio outputs can be produced without delay after the start of the reading.

While the novel features of the present invention are set forth in the appended claims, the present invention will be better understood from the following detailed description taken in conjunction with the drawings.

### BRIEF DESCRIPTION OF THE DRAWINGS

The present invention will be described hereinafter with reference to the annexed drawings. It is to be noted that all the drawings are shown for the purpose of illustrating the technical concept of the present invention or embodiments thereof, wherein:

FIG. 1 is an electrical block diagram schematically showing an optical disc apparatus according to one embodiment of the present invention;

FIG. 2 is an electrical block diagram schematically showing a servo controller and a servo gain adjuster in the optical disc apparatus; and

FIGS. 3A and 3B show the conventional method for calculating the amount of servo gain adjustment.

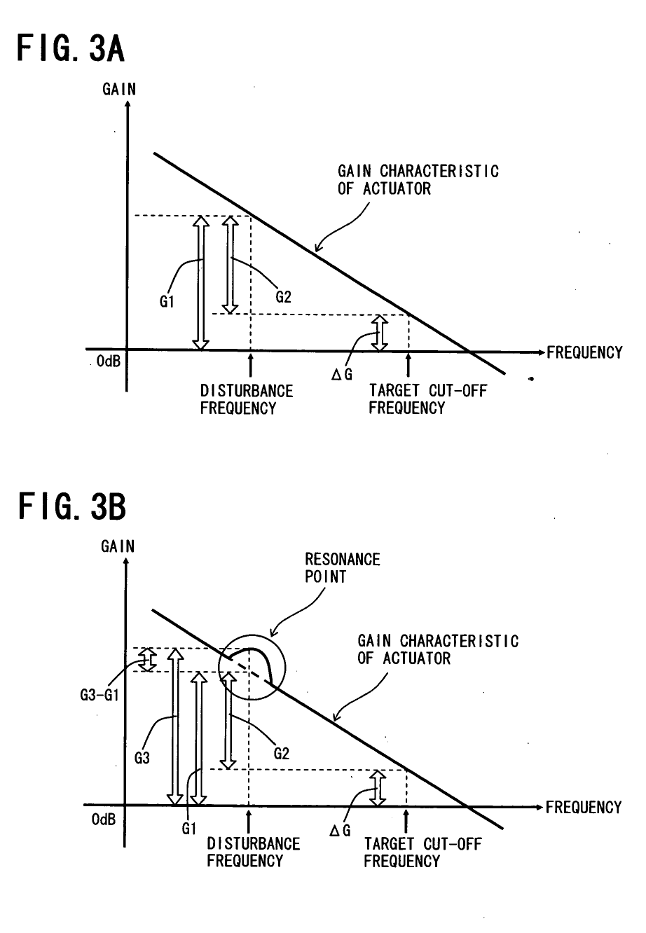

### DESCRIPTION OF THE PREFERRED EMBODIMENTS

Referring now to the accompanying drawings, an optical disc apparatus according to one embodiment of the present invention is described. It is to be noted that the following description of preferred embodiment of the present invention has been presented for purposes of illustration and description, and is not intended to be exhaustive or to limit the present invention to the precise form disclosed.

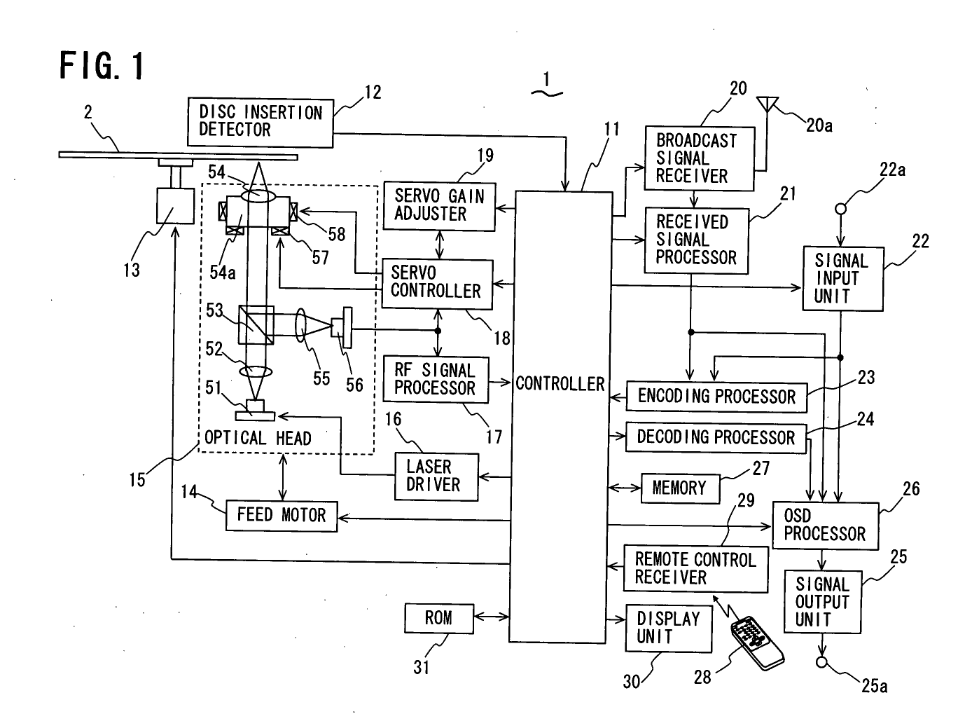

FIG. 1 shows the configuration of the optical disc apparatus 1 according to this embodiment. The optical disc apparatus 1 is an apparatus that records and/or reproduces information such as, for example, video, audio, and text on an optical disc 2 such as a CD, a DVD, or the like having recording tracks formed concentrically or spirally thereon.

The optical disc apparatus 1 comprises a controller 11 including a central processing unit (CPU) for controlling each component in the optical disc apparatus 1, a disc insertion detector 12, a spindle motor 13, a feed motor 14, an optical head 15, a laser driver 16, an RF signal processor 17, a servo controller 18, and a servo gain adjuster 19. The optical disc apparatus 1 further comprises a broadcast signal receiver 20, a received signal processor 21, a signal input unit 22, an encoding processor 23, a decoding processor 24, a signal output unit 25, an on-screen display (OSD) processor 26, a memory 27, a remote control 28, a remote control receiver 29, a display unit 30, and a read-only memory (ROM) 31.

The disc insertion detector 12 detects the optical disc 2 inserted into a disc insertion slot (not shown), and inputs the detection signal to the controller 11. The optical disc 2 inserted into the disc insertion slot is mounted on the spindle motor 13. The spindle motor 13 is rotated under the control of the controller 11 so as to rotate the mounted optical disc 2. The feed motor 14 comprises a linear motor, and moves the optical head 15 over the optical disc 2 in a radial direction of the optical disc 2 under the control of the controller 11.

The optical head 15 records information on the optical disc 2 mounted on the spindle motor 13 by irradiating the optical disc 2 with light to form pits on the optical disc 2, and reads information recorded on the optical disc 2 by irradiating the optical disc 2 with light and receiving the reflected light to detect pits formed on the optical disc 2. The optical head 15 comprises a semiconductor laser 51 that is a light emitting element, a collimating lens 52, a beam splitter 53, an objective lens 54, a collecting lens 55, a light receiving element 56, and a focusing coil 57 and a tracking coil 58 that are actuators to move the objective lens 54.

The semiconductor laser 51 is driven by the laser driver 16 to emit light for recording or reading information to or from the optical disc 2. The light emitted from the semiconductor laser 51 is collected and focused onto the optical disc 2 through the collimating lens 52, the beam splitter 53, and the objective lens 54. Light reflected from the optical disc 2 is collected onto the light receiving element 56 through the objective lens 54, the beam splitter 53 and the collecting lens 55.

The objective lens 54 is held by a lens holder 54a. Under the control of the servo controller 18, the objective lens 54 is moved in a direction perpendicular to the information recording surface of the optical disc 2 mounted on the spindle motor 13 by the magnetic force of the focusing coil 57 and moved in a radial direction of the optical disc 2 (direction parallel to the information recording surface of the optical disc 2 and perpendicular to the recording tracks of the optical disc 2) by the magnetic force of the tracking coil 58. The movement of the objective lens 54 is used to adjust the position of the focused spot and the spot diameter of the light that is emitted from the semiconductor laser 51 to be focused onto the optical disc 2.

The light receiving element 56 receives light that is reflected from the optical disc 2 and passes through the objective lens 54, the beam splitter 53, and the collecting lens 55. The light receiving surface of the light receiving element 56 is divided into multiple areas. The multiple areas of the light receiving element 56 respectively output electric signals according to the light intensities received thereby.

The optical head 15 irradiates the optical disc 2 with light emitted from the semiconductor laser 51, and thereby changes the properties of the recording layer of the optical disc 2, so as to form pits on the optical disc 2. Further, the optical head 15 irradiates the optical disc 2 with light emitted from the semiconductor laser 51 in order for the light receiving element 56 to receive light reflected from the optical disc 2, so as to detect the pits formed on the recording layer of the optical disc 2. For detecting the pits, the intensity of the light emitted from the semiconductor laser 51 is weakened so as to prevent the property change of the recording layer of the optical disc 2.

The laser driver 16 controls emission timing and emission intensity of the semiconductor laser 51 under the control of the controller 11. Based on output signals from the light receiving element 56, the RF signal processor 17 generates a RF signal (reflection intensity signal) that varies in intensity depending on the presence or absence of pits ands outputs the RF signal to the controller 11.

Based on the output signal from the light receiving element 56, the servo controller 18 generates drive signals for the focusing coil 57 and the tracking coil 58 and drives the focusing coil 57 and the tracking coil 58 by the generated drive signals to move the objective lens 54, for servo control such that the focused spot of light emitted from the semiconductor laser 51 to be focused onto the optical disc 2 follows the recording track of the optical disc 2.

Under the control of the controller 11, the servo gain adjuster 19 supplies a disturbance signal to the servo loop, which includes the objective lens 54, the light receiving element 56, the servo controller 18, the focusing coil 57, and the tracking coil 58, so as to adjust the gain of the servo controller 18 (i.e., the servo gain of the servo loop) based on the disturbance signal passed through the servo loop.

The receiving frequency of the broadcast signal receiver 20 is tuned to a frequency of a television signal transmitted from a broadcast station so as to receive the television signal via an antenna 20a, under the control of the controller 11. The received signal processor 21 demodulates the television signal received by the broadcast signal receiver 20 so as to produce video and audio signals, under the control of the controller 11. Under the control of the controller 11, the signal input unit 22 receives various signals representing information such as video, audio, and text that are input via a signal input terminal 22a from external devices such as a video camera, a digital camera, and a personal computer.

Under the control of the controller 11, the encoding processor 23 encodes video and audio signals produced at the received signal processor 21 and signals input through the signal input unit 22 into a given format for recording as encoded data on the optical disc 2. The decoding processor 24 decodes encoded data read from the optical disc 2 under the control of the controller 11.

The signal output unit 25 outputs video and audio signals produced at the received signal processor 21, signals input through the signal input unit 22, and signals decoded by the decoding processor 24 to external devices such as a display, a speaker, and a personal computer via a signal output terminal 25a, under the control of the controller 11. Under the control of the controller 11, the OSD processor 26 superimposes on-screen image signals on the video signals produced at the received signal processor 21, the signals input through the signal input unit 22, and the signals decoded by the decoding processor 24 for display of an on-screen image on the display.

The memory 27 temporarily stores e.g. encoded data to be recorded to the optical disc 2 and encoded data read from the optical disc 2 under the control of the controller 11. Further, the memory 27 stores e.g. graphics data based on which the on-screen image is generated.

The remote control 28 is operated by a user to enter commands into the optical disc apparatus 1 for various operations including: selection of a channel on which television signals are to be received; recording of information such as video, audio, and/or text to the optical disc 2; and reproduction of information recorded on the optical disc 2. The remote control 28 has various operation keys (detailed description omitted) to be operated by the user for entering the commands for the various operations into the optical disc apparatus 1. When the user operates the various operation keys, the remote control 28 sends out coded infrared signals that correspond to the operations.

The remote control receiver 29 receives infrared signals sent out from the remote control 28, and converts the received infrared signals to electric signals, and further outputs, to the controller 11, the signals corresponding to the commands entered by the remote control 28. The display unit 30 is provided on a front panel of the main body of the optical disc apparatus 1 so as to display information indicating the operation requested by the remote control 28, operational states of the optical disc apparatus 1, and so on. The ROM 31 stores operation programs for the controller 11.

The controller 11 determines what operations are requested by the remote control 28 based on the output signals from the remote control receiver 29, and controls various operations including an operation of receiving television signals, an operation of recording information such as video, audio, and/or text on the optical disc 2, and an operation of reproducing information recorded on the optical disc 2.

For recording information on the optical disc 2, the encoding processor 23 encodes video and audio signals produced at the received signal processor 21 or signals input through the signal input unit 22. Then, the optical head 15 forms on the optical disc 2 pits with lengths and arrangement corresponding to the encoded data so as to record the encoded data on the optical disc 2.

For reproducing information recorded on the optical disc 2, the optical head 15 detects pits formed on the optical disc 2. Based on output signals from the optical head 15, the RF signal processor 17 generates and outputs RF signals. Based on the RF signals, the controller 11 determines the lengths and arrangement of the pits to read encoded data. Then, the decoding processor 24 decodes the encoded data so that the decoded signal is output through the signal output unit 25.

The optical disc 2 has recording tracks concentrically or spirally formed at a given pitch. Each of the recording tracks includes multiple sectors, in each of which an address identifying the sector is prerecorded in the form of pits.

The optical head 15 forms pits (i.e., records encoded data) on the optical disc 2 by irradiating the optical disc 2 with light while the spindle motor 13 rotates the optical disc 2. Further, the optical head 15 detects pits formed (i.e., reads encoded data recorded) on the optical disc 2 by irradiating the optical disc 2 with light to receive the light reflected from the optical disc 2 while the spindle motor 13 rotates the optical disc 2.

The controller 11 controls the rotation of the spindle motor 13 and the light emission of the optical head 15 to control the operation of recording or reading encoded data to or from the optical disc 2. The controller 11 reads the address of each sector on the optical disc 2 for identification of the sector so that encoded data is recorded/read by sector.

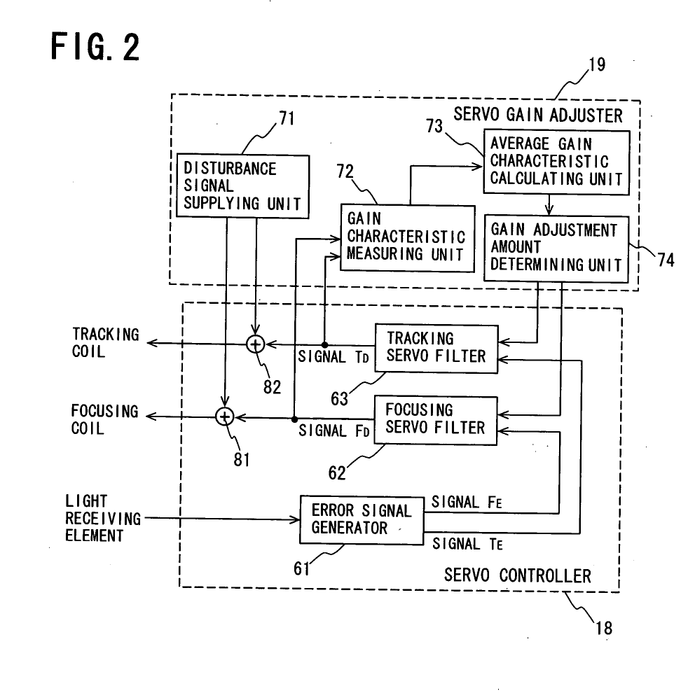

FIG. 2 shows the configuration of the servo controller 18 and the servo gain adjuster 19. The servo controller 18 comprises an error signal generator 61, a focusing servo filter 62, and a tracking servo filter 63. The servo gain adjuster 19 comprises a disturbance signal supplying unit 71, a gain characteristic measuring unit 72, an average gain characteristic calculating unit 73, and a gain adjustment amount determining unit 74.

Based on an output signal from the light receiving element 56, the error signal generator 61 generates a focusing error signal FE and a tracking error signal TE. The focusing error signal FE is a signal corresponding to the amount of deviation of the focus of light, which is emitted to be focused through the objective lens 54 onto the optical disc 2, from the information recording surface of the optical disc 2 in the direction perpendicular to the information recording surface. The tracking error signal TE is a signal corresponding to the amount of deviation of the focus of light, which is emitted to be focused through the objective lens 54 onto the optical disc 2, in the radial direction from the recording track of the optical disc 2.

The focusing servo filter 62 generates a focusing drive signal FD, which is a signal for driving the focusing coil 57, based on the focusing error signal FE generated at the error signal generator 61. The focusing drive signal FD is used for driving the focusing coil 57 to move the objective lens 54 in the direction perpendicular to the information recording surface of the optical disc 2. The focusing servo filter 62 generates the focusing drive signal FD so as to cancel out the focusing error signal FE generated at the error signal generator 61 (i.e., to cancel out the amount of focus deviation of the light in the direction perpendicular to the information recording surface of the optical disc 2).

The tracking servo filter 63 generates a tracking drive signal TD, which is a signal for driving the tracking coil 58, based on the tracking error signal TE generated at the error signal generator 61. The tracking drive signal TD is used for driving the tracking coil 58 to move the objective lens 54 in the radial direction of the optical disc 2. The tracking servo filter 63 generates the tracking drive signal TD so as to cancel out the tracking error signal TE generated at the error signal generator 61 (i.e., to cancel out the amount of focus deviation of the light in the radial direction of the optical disc 2).

With the above configuration, the servo controller 18 generates the focusing drive signal FD and the tracking drive signal TD and drives the focusing coil 57 and the tracking coil 58 by the generated focusing drive signal FD and the tracking drive signal TD to move the objective lens 54 so that the spot of light focused onto the optical disc 2 follows the recording track of the optical disc 2.

The disturbance signal supplying unit 71 supplies a disturbance signal to the focusing servo loop, which includes the objective lens 54, the light receiving element 56, the focusing coil 57, and the focusing servo filter 62, by adding the disturbance signal to the focusing drive signal FD via an adder 81. Further, the disturbance signal supplying unit 71 supplies a disturbance signal to the tracking servo loop, which includes the objective lens 54, the light receiving element 56, the tracking coil 58, and the tracking servo filter 63, by adding the disturbance signal to the tracking drive signal TD via an adder 82. The disturbance signal supplying unit 71 is adapted to generate plural types of, e.g. about two to ten types of, disturbance signals that have different frequencies. Under the control of the controller 11, the disturbance signal supplying unit 71 generates the plural types of disturbance signals to supply them in sequence to each of the focusing servo loop and the tracking servo loop.

The gain characteristic measuring unit 72 detects each disturbance signal supplied to the focusing servo loop by the disturbance signal supplying unit 71 and passed through the focusing servo loop, and measures a deviation of the servo gain characteristic of the focusing servo loop. Further, the gain characteristic measuring unit 72 detects each disturbance signal supplied to the tracking servo loop by the disturbance signal supplying unit 71 and passed through the tracking servo loop, and measures a deviation of the servo gain characteristic of the tracking servo loop.

For each of the focusing and tracking servo loops, the average gain characteristic calculating unit 73 calculates the average of deviations of plural servo gain characteristics measured by the gain characteristic measuring unit 72 in response to the plural types of disturbance signals supplied from the disturbance signal supplying unit 71.

The gain adjustment amount determining unit 74 determines an adjustment amount for the servo gain of the focusing servo loop based on the average of the deviations of the servo gain characteristics that is calculated for the focusing servo loop by the average gain characteristic calculating unit 73. Further, the gain adjustment amount determining unit 74 determines an adjustment amount for the servo gain of the tracking servo loop based on the average of the deviations of the servo gain characteristics that is calculated for the tracking servo loop by the average gain characteristic calculating unit 73.

With the above configuration, the servo gain adjuster 19 determines the servo gain adjustment amount for each of the focusing servo loop and the tracking servo loop by using the plural disturbance signals of different frequencies. In accordance with the determined adjustment amount, the servo gain adjuster 19 increases or decreases the gain of each of the focusing servo filter 62 and the tracking servo filter 63, thereby adjusting the servo gain of each of the focusing servo and tracking servo loops.

The servo gain adjustment is performed, for example, when information is recorded/reproduced on the optical disc 2 in response to a command entered by the remote control 28, and when the optical disc 2 is mounted on the spindle motor 13.

As described above, the optical disc apparatus 1 uses the plural disturbance signals of different frequencies for adjustment to the servo gain. This can prevent the servo gain from being adjusted to be undesirably high (or low) even when the frequency characteristic of the actuator has a resonance point at the same frequency as the frequency of one of the disturbance signals, thus allowing proper adjustments to the servo gain. Accordingly, the optical disc apparatus 1 can provide stable servo gain adjustments and thus increase in performance. Further, the servo gain is adjusted based on the average of deviations of servo gain characteristics measured using the plural disturbance signals of different frequencies. This allows the servo gain to be adjusted more properly and more stably. Moreover, since about two to ten types of disturbance signals are used for adjusting the servo gain, the adjustment does not require much time. Accordingly, when information is read from the optical disc 2, video and audio outputs can be produced without delay after the start of the reading.

The present invention has been described above using a presently preferred embodiment, but those skilled in the art will appreciate that various modifications are possible. Accordingly, all such modifications are intended to be included within the spirit and scope of the present invention. For example, a disturbance signal can be supplied to the servo loop by adding the disturbance signal to the output signal from the light receiving element 56, the focusing error signal FE, or the tracking error signal TE, instead of adding the disturbance signal to the focusing drive signal FD or the tracking drive signal TD. Further, the servo gain adjustment is not necessarily performed using about two to ten types of disturbance signals that have different frequencies but can be performed using more disturbance signals of different frequencies.

This application is based on Japanese patent application 2004-362943 filed Dec. 15, 2004, the contents of which are hereby incorporated by reference.

What is claimed is:

1. An optical disc apparatus comprising:
a light emitting element that emits light for recording and/or reading information on an optical disc;
an objective lens for focusing the light emitted from the light emitting element onto the optical disc;
an actuator that moves the objective lens;
a light receiving element that receives the light focused through the objective lens onto the optical disc and reflected from the optical disc to convert the light into an electric signal for output;
a servo controller that generates a drive signal for the actuator based on the output signal from the light receiving element and drives the actuator by the drive signal to move the objective lens such that the focused spot of the light focused onto the optical disc follows a recording track of the optical disc; and
a servo gain adjuster that supplies a disturbance signal to a servo loop to adjust a servo gain of the servo loop based on the disturbance signal passed through the servo loop, the servo loop including the objective lens, the actuator, the light receiving element, and the servo controller,
wherein the servo gain adjuster supplies plural disturbance signals of different frequencies to the servo loop and adjusts the servo gain of the servo loop based on the plural disturbance signals passed through the servo loop.

2. The optical disc apparatus according to claim 1, wherein the servo gain adjuster includes:
a gain characteristic measuring unit that measures a deviation of a servo gain characteristic of the servo loop based on a disturbance signal passed through the servo loop; and
an average gain characteristic calculating unit that calculates an average of deviations of plural servo gain characteristics measured in response to the plural disturbance signals by the gain characteristic measuring unit,
wherein the servo gain adjuster adjusts the servo gain of the servo loop based on the average of the deviations of the servo gain characteristics that is calculated by the average gain characteristic calculating unit.

3. The optical disc apparatus according to claim 1, wherein the servo gain adjuster includes:
a disturbance signal supplying unit that generates plural disturbance signals of different frequencies and supplies the plural disturbance signals in sequence to the servo loop;
a gain characteristic measuring unit that measures a deviation of a servo gain characteristic of the servo loop based on a disturbance signal supplied to the servo loop by the disturbance signal supplying unit and passed through the servo loop;
an average gain characteristic calculating unit that calculates an average of deviations of plural servo gain characteristics measured by the gain characteristic measuring unit in response to the plural disturbance signals supplied from the disturbance signal supplying unit; and
a gain adjustment amount determining unit that determines an amount of adjustment to the servo gain of the servo loop based on the average of the deviations of the servo gain characteristics that is calculated by the average gain characteristic calculating unit.

4. The optical disc apparatus according to claim 3, wherein the plural disturbance signals supplied to the servo loop are two to ten types of disturbance signals that have different frequencies.
